(19) United States
(12) Patent Application Publication
(10) Pub. No.: US 2010/0056393 A1
(43) Pub. Date: Mar. 4, 2010

(54) APPARATUS AND METHOD FOR DETECTING A TARGET USING SURFACE PLASMON RESONANCE

(76) Inventors: Sunghoon Kwon, Seoul (KR); Seung Ah Lee, Seoul (KR)

Correspondence Address: Sunghoon Kwon;Faculty APT 122-I-104, San 4-2, Bongchun 7 Dong, Gwanak-Gu, Seoul, KR

(21) Appl. No.: 12/199,615

(22) Filed: Aug. 27, 2008

(51) Int. Cl. C40B 30/10; C40B 40/00; C40B 40/08; C40B 50/14; C40B 40/10; C40B 60/12

(52) U.S. Cl. 506/12; 506/13; 506/17; 506/18; 506/39; 506/30

(57) ABSTRACT

Disclosed are substrates for detecting one or more target molecules and methods for detecting molecules using surface plasmon resonance.

### BACKGROUND

Surface plasmon resonance (SPR) is a technique that may be used to study the binding of molecules to the surface of a substrate. However, many SPR systems provide only low signal-to-noise ratios, making detection of small amounts of molecules difficult.

### SUMMARY

One aspect is drawn to a substrate for detecting one or more target molecules using surface plasmon resonance. The substrate comprises one or more detection zones on the surface of the substrate and a collection of nanodots disposed within one or more of the one or more detection zones. The nanodots are functionalized with one or more probe molecules having an affinity for the target molecules.

In some aspects, the area of one or more of the one or more detection zones is from about 1 μm² to about 10,000 μm². In some aspects, the nanodots form a lattice pattern, a spiral pattern, a concentric circular pattern, or a radial pattern. In some aspects, the diameter of the nanodots is from about 1 nm to about 100 nm. In some aspects, the nanodots comprise a metal. The metal is selected from the group consisting of Au, Ag, Cu, and Al.

In some aspects, the probe molecules of one collection of nanodots disposed within one detection zone are different from the probe molecules of another collection of nanodots disposed within another detection zone. In some aspects, the probe molecules comprise biomolecules. The biomolecules are selected from the group consisting of DNA, RNA, peptides, and enzymes.

Another aspect is drawn to a system for detecting one or more target molecules using surface plasmon resonance. The system comprises the substrate of the detection of target molecules, a light source adapted to generate a surface plasmon resonance signal from the substrate, and a detector adapted to detect the signal.

In some aspects, the power of the signals from one detection zone of the substrate corresponds to a value obtained by multiplying the signal power of one nanodot in the one detection zone by the number of the nanodots disposed within the one detection zone. The area of one or more of the detection zones may be from about 1 μm² to about 10,000 μm². The nanodots may form a lattice pattern, a spiral pattern, a concentric circular pattern, or a radial pattern. The diameter of the nanodots may be from about 1 nm to about 100 nm. The nanodots may comprise a metal selected from the group consisting of Au, Ag, Cu and Al. The probe molecules of one collection of nanodots disposed within one detection zone may be different from the probe molecules of another collection of nanodots disposed within another detection zone. The probe molecules may comprise biomolecules selected from the group consisting of DNA, RNA, peptides and enzymes.

Still another aspect is drawn to a method of detecting one or more target molecules using surface plasmon resonance. The method comprises exposing a substrate to one or more target molecules. The substrate comprises one or more detection zones on the surface of the substrate and a collection of nanodots disposed within one or more of the one or more detection zones. The nanodots are functionalized with one or more probe molecules having an affinity for the target molecules. The method further comprises measuring a surface plasmon resonance signal from the substrate.

In some aspects, the measuring a surface plasmon resonance signal comprises obtaining the power value of the signal by multiplying the signal power of one nanodot on the one detection zone by the number of the nanodots disposed within the one detection zone. The probe molecules may be selected from the group consisting of DNA, RNA, peptides and enzymes.

Still another aspect is drawn to a method of manufacturing a substrate for detecting one or more target molecules using surface plasmon resonance. The method comprises forming one or more detection zones on the surface of the substrate and forming a collection of nanodots disposed within one or more of the one or more detection zones.

In some aspects, the method further comprises functionalizing nanodots with one or more probe molecules having an affinity for the target molecules. The probe molecules of one collection of nanodots disposed within one detection zone may be different from the probe molecules of another collection of nanodots disposed within another detection zone. The probe molecules may be selected from the group consisting of DNA, RNA, peptides and enzymes. The nanodots may comprise a metal selected from the group consisting of Au, Ag, Cu and Al.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 depicts an illustrative embodiment of a substrate including a detection zone and a collection of functionalized nanodots within the zone.

FIG. 2 depicts an illustrative embodiment of a method for obtaining a substrate material

FIGS. 3a to 3e depict illustrative embodiments of a method for forming a substrate including a detection zone and a collection of nanodots within the zone.

FIG. 4 depicts an illustrative embodiment of a system for the detection of target molecules including a light source, a substrate, and a detector.

FIGS. 5a and 5b depict illustrative embodiments of target molecules binding to functionalized nanodots.

FIGS. 6a and 6b show illustrative embodiments of the SPR signal of a substrate before and after being exposed to target molecules.

### DETAILED DESCRIPTION

In the following detailed description, reference is made to the accompanying drawing, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Disclosed herein are substrates and systems for detecting one or more target molecules using SPR. The substrates include one or more detection zones on the surface of the substrate and a collection of nanodots disposed within each of the detection zones. The nanodots are functionalized with one or more probe molecules having an affinity for the target molecules. The systems include the disclosed substrates, a light source for generating light irradiated to the substrate to generate a surface plasmon resonance signal, and a detector for detecting the surface plasmon resonance signal. Because the substrates and systems have a collection of nanodots disposed with each of the detection zones, the surface plasmon resonance signals can be generated on each of the nanodots, thereby inducing localized surface plasmon (LSP). As a result, the signal powers of the detection zones are increased, and thus the signal-to-noise ratio of the system is improved. By increasing the number of nanodots available to capture target molecules in a given detection zone, the signal-to-noise ratio of the systems is improved over conventional SPR systems. Also disclosed herein are methods related to the substrates and systems.

The substrates disclosed herein include one or more detection zones on the surface of the substrate. As used herein, the “detection zone” refers to the zone in which a SPR signal is generated in response to the light illuminated to the substrate. The size of the detection zone may vary. In some embodiments, the area of the detection zone is from about 1 μm² to about 10,000 μm². In other embodiments, the area of the detection zone is from about 10 μm² to about 1000 μm². Other areas are possible.

Disposed within the one or more detection zones is a collection of nanodots. In some aspects, each of the detection zones included a collection of nanodots. In other aspects, at least one detection zone includes a collection of nanodots. Similarly, each detection zone may include the same number of the nanodots, or each detection zone may include a different number of the nanodots. The collection of nanodots may form various patterns. Patterns include, but are not limited to a lattice pattern, a spiral pattern, a concentric circular pattern, or a radial pattern. The area of the nanodots may vary. In some embodiments, the area of the nanodot is from about 1 nm² to about 10000 nm². In other embodiments, the area of the nanodot is from about 10 nm² to about 1000 nm². The diameter of the nanodots may vary. In some aspects, the diameter is from about 1 nm to about 100 nm. The composition of the nanodots may vary. In some embodiments, the nanodots comprise a metal. A variety of metals may be used, including, but not limited to Au, Ag, Cu, and Al.

A variety of well-known methods may be used to form the detection zones having a collection of nanodots, including, but not limited to electron beam nanolithography, X-ray lithography, and nano-imprinting. These methods are further described below.

The nanodots within the collection of nanodots are functionalized with one or more probe molecules having an affinity for a target molecule. In some embodiments, each of the nanodots within a given collection is functionalized with one or more probe molecules. However, in other embodiments, one or more nanodots within a given collection may not be functionalized. The probe molecules disclosed herein selectively recognize even small amounts of target molecules. A variety of probe molecules may be including, but not limited to biomolecules, organic compound, and inorganic compound. Non limiting examples of biomolecules include DNA, RNA, peptides, and enzymes. Similarly, the disclosed technology encompasses a variety of target molecules. A variety of target molecules may be used, including, but not limited to biomolecules, organic compounds, and inorganic compounds. Non-limiting examples of the biomolecules include DNA, RNA, peptides, and enzymes. Specific probe molecule and target molecule pairs include, but are not limited to, DNA-complementary DNA and antibody-antigen as further described below. Probe molecules may be attached to the nanodots by a variety of well-known techniques.

The probe molecules of a given collection of nanodots may be the same or different. By way of example only, some of the nanodots in a collection may be functionalized with one type of probe molecule, while others in the collection may be functionalized with a different type of probe molecule. In other embodiments, the probe molecules of a given collection of nanodots are the same.

Similarly, the probe molecules of one collection of nanodots may be the same or different from the probe molecules of another collection of nanodots. By way of example only, one detection zone may include a collection of nanodots functionalized with one type of probe molecule and another detection zone may include a collection of nanodots functionalized with a different type of probe molecule. Such an embodiment allows for the parallel detection of a mixture of different target molecules having affinities to different probe molecules. In other embodiments, the probe molecules of one collection of nanodots within one detection zone are the same as the probe molecules of another collection of nanodots within another detection zone.

Also disclosed are systems for detecting one or more target molecules using surface plasmon resonance. The systems comprise any of the substrates for detecting target molecules as described herein. The systems also comprise a light source adapted to generate a SPR signal from the substrate and a detector adapted to detect the SPR signal. The light source illuminates the functionalized nanodots on the surface of the substrate, generating surface plasmons and an SPR signal from the substrate. When other molecules, such as target molecules, attach to the probe molecules on the nanodots, the SPR signal changes due to changes in the local index of refraction of the substrate. The SPR signal from the substrate and any changes in the signal are detected by the detector. Because the substrates and systems have a collection of nanodots disposed with each of the detection zones, the surface plasmon resonance signals can be generated on each of the nanodots, thereby inducing LSP. As a result, the signal powers of the detection zones are increased, and thus the signal-to-noise ratio of the system is improved. Thus, by increasing the number of nanodots available to capture target molecules in a given detection zone, the signal-to-noise ratio of the systems is improved over conventional SPR systems. Because the LSP is induced by a collection nanodots in a given detection zone to detect target molecules, the systems disclosed herein are capable of achieving high signal power and high signal-to-noise ratios compared to conventional SPR substrates and SPR systems. Accordingly, the detection error of the system is reduced and the detection speed of the system is enhanced.

A variety of light sources and detectors may be used. By way of example only, the light source may be a white light source, such as a halogen lamp. The power of the halogen lamp may vary. Similarly, a variety of detectors may be used. By way of example only, the detector may be a CCD camera.

The systems may further include a variety of other elements. By way of example only, the systems may include elements for selecting a particular wavelength of light, such as a monochromator, and other optical elements for directing the light source to the substrate and for facilitating the generation of the surface plasmons. Optical elements include but not are limited to a beam collimator, a beam expander, and a darkfield condenser. The systems may also include optical elements for collecting the SPR signal from the substrate and directing it to the detector. Such optical elements include, but are not limited to microscope objectives and focusing lenses. The systems may further include a processor for analyzing, displaying, and storing the information captured by the detector. The systems may further include a control unit for controlling and/or coordinating the various elements of the system. Various embodiments of the systems are further described below.

Also disclosed are methods of detecting one or more target molecules using surface plasmon resonance. The methods comprise exposing any of the substrates disclosed herein to one or more target molecules and measuring a surface plasmon resonance signal from the substrate. Various embodiments of the methods are further described below.

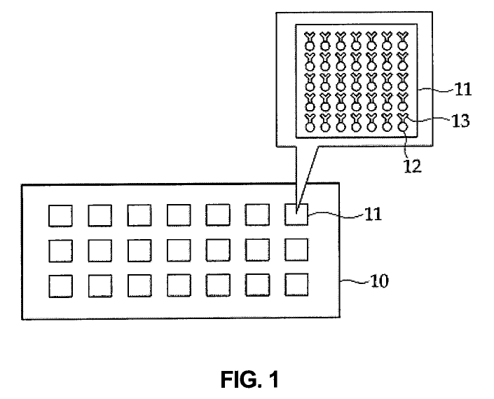

FIGS. 1-6 depict illustrative embodiments of the substrates, systems, and methods disclosed herein. FIG. 1 shows a substrate 10 for the detection of target molecules, which has a plurality of detection zones 11 on its surface. Each of the detection zones 11 includes a collection of nanodots 12. Probe molecules 13 are attached to each of the nanodots 12. In this embodiment, the nanodots 12 form a lattice pattern, and all of the nanodots 12 are functionalized with the same probe molecules. However, as described above, the nanodots may form a spiral pattern, a concentric circular pattern, or a radial pattern. Further, even though the same probe molecules are functionalized with the nanodots 12 in this embodiment, different probe molecules may be functionalized with the nanodots 12.

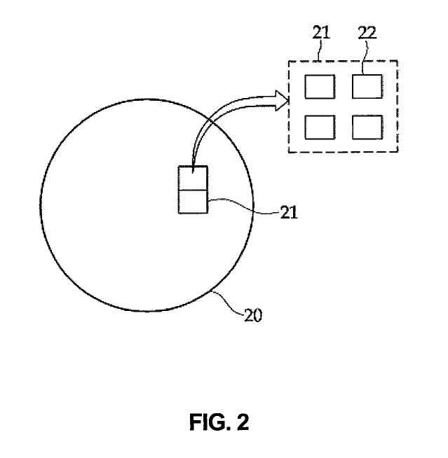

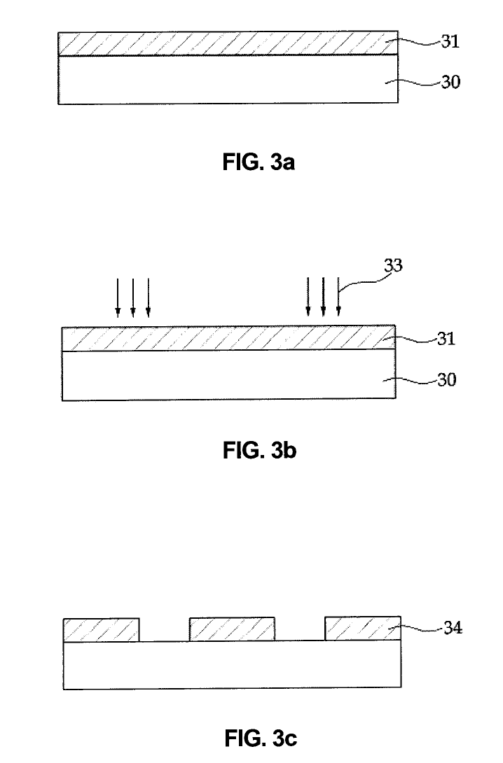

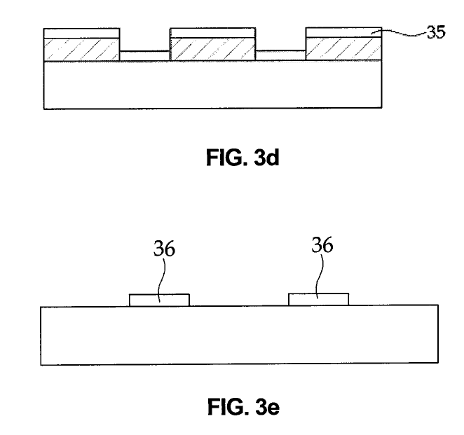

FIGS. 2-3 show a method of manufacturing a substrate. FIG. 2 is a schematic illustrating a method used for forming the substrate 10 for the detection of target molecules, according to one embodiment. In some embodiments, a die 21 may be manufactured from a quartz wafer 20. Each die 21 may be used as the substrate for the detection of target molecules. Each die 21, as used for the substrate for the detection of target molecules, may have one or more detection zone 22 having a collection of nanodots therein formed by e-beam lithography. The detection zone 22 on the surface of the substrate 10 can be formed as shown in FIGS. 3a to 3e.

FIGS. 3a to 3e are schematics, each illustrating a method for forming the detection zone on the surface of the substrate for the detection of target molecules. A photoresist 31 of polymethyl methacrylate (PMMA) is first spin coated on a transparent substrate such as a quartz substrate 30 of Si (FIG. 3a). A desired pattern for a collection of nanodots in one detection zone is transferred onto the surface of the photoresist 31, and the Si substrate 30 is exposed to an electron beam 33 (FIG. 3b). Thereafter, the Si substrate 30 is developed with a developing solution, which may include, but is not limited to MIBK/IPA (metal iso-butyl ketone/Isopropanol) to form the desired pattern 34 for a collection of nanodots (FIG. 3c). Then, a metal layer 35 is deposited on the pattern 34 to form a collection of nanodots (FIG. 3d). Finally, the pattern 34 is lifted off from the substrate 30 by a cleansing agent and then a collection of nanodots 36 are left remaining on the Si substrate 30 (FIG. 3e). The Si substrate 30 on which the collection of nanodots 36 can be used as the detection zone. The areas and the intervals of the nanodots 36 can be appropriately adjusted by controlling the conditions of the lithography used for forming the patterns 34 for a collection of nanodots. Scanning Electron Microscopy (SEM) may be used to image the substrates thus formed.

As described above, other techniques besides e-beam lithography may be used, including, but not limited to nano-imprinting. In nano-imprinting, the nanodots may be formed by assembling metal nanoparticles into templates and imprinting the assembled nanoparticles to the desired location.

The probe molecules may be attached to the nanodots during the method for manufacturing the substrate, or after the substrate has been formed, by using any technology known to one of skilled in the field of DNA nanotechnology.

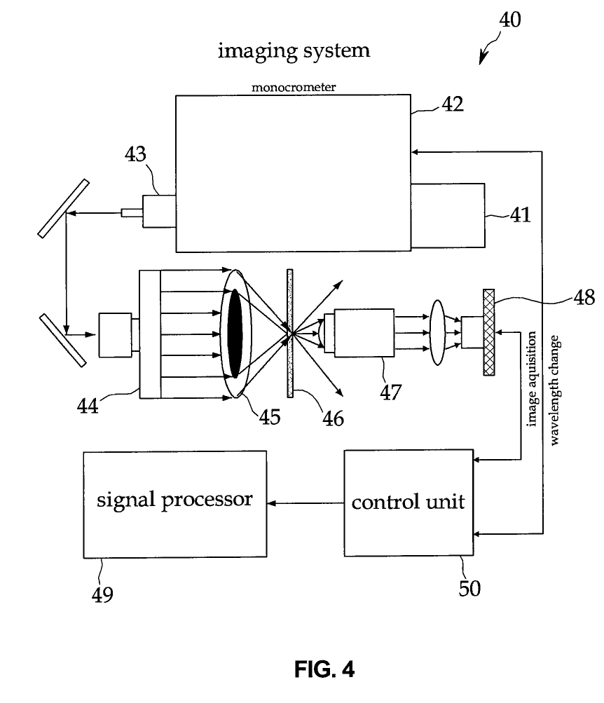

FIG. 4 depicts an illustrative embodiment of a system 40 for the detection of target molecules using surface plasmon resonance. The system 40 includes a substrate 46 for the detection of target molecules using SPR. The system 40 also includes a light source 41, a monochromator 42, a beam collimator 43, a beam expander 44, and a darkfield condenser 45. Light from the light source 41 illuminates the substrate 46 (which includes the detection zones having functionalized nanodots), generating surface plasmons and a SPR signal. The system 40 also includes an objective lens 47, and a detector 48 for detecting the SPR signal from the substrate 46. A processor 49 and control unit 50 are also shown. The control unit 50 may be used to control and/or coordinate the light source 41 and the detector 48. The control unit 50 may also be used to control the position of the substrate 46.

In some embodiments, when the substrate for the detection of target molecules 46 including the probes attached to the respective nanodots is prepared, the light source 41, such as white light source, irradiates excited light to the substrate 46 in order to generate surface plasmons. For example, when the exited light is irradiated onto the target bound with the probes of the nanodots, the refractive index in the metal surface of the substrate 46 is changed. The processor 49 analyzes the changes of the refractive index and a surface plasmon resonance angle by processing the optical signals collected from the substrate 46. The irradiated light may be, but is not limited to white light generated from the light source 41. The white light generated from the light source 41 is directed to the monochromator 42 controlled by a computer program in order to output a monochromatic light beam while changing a wavelength and a specific spectrum step size thereof. Here, the power of the light outputs is, but is not limited to about 100 to 300 μW/cm²/nm. The spectrum width of the monochromatic light is not more than about 2 nm. The width, however, is not limited to about 2 nm. Thereafter, a monochromatic light beam is irradiated by the darkfield condenser 65 (N.A.=1.2 to 1.4) with immersion oil (n=5.8) onto the target combined to the nanodot arrays of the substrate for the detection of target molecules 46.

When the excited light is irradiated onto the target molecules bound with the probe molecules of the nanodots, the SPR angle of the substrate 46 is changed. The light scattered from the substrate 46 is collected by the microscopy objective lens 47 (N.A.=0.8) and the collected light is captured by the detector 48, such as a CCD camera.

In some embodiments, the monochromator and image capture control software may be incorporated to be synchronized so as to capture a single image at each desired wavelength. The image captured by the detector 48 as described above may be transferred to the processor 49 so as to be processed and analyzed. In some embodiments, the captured image may be stored as a compressed data file and may be analyzed by an image processing program in the processor 49. This process for image analysis and spectra data reconstruction may be optionally automated by a computer program.

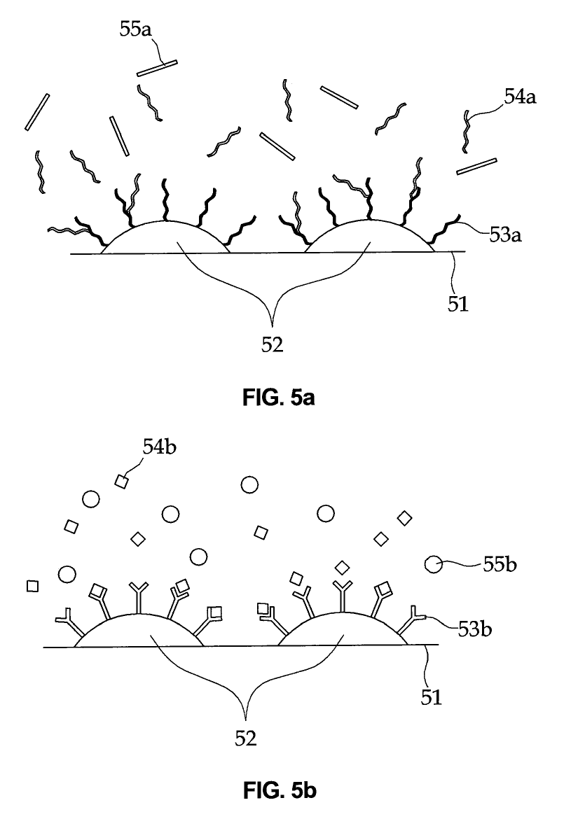

FIG. 5 depicts an illustrative embodiment of the detection of target molecules using the substrates and systems disclosed herein. In FIG. 5a, nanodots 52 are disposed within a detection zone on the surface of a substrate 51. The nanodots are functionalized with DNA probe molecules 53a. The DNA 53a on the nanodots is complementary to the target molecule DNA 54a. DNA 55a is a molecule that does not have a complementary sequence to the probe molecule DNA. The binding of the target DNA 54a to the probe molecule DNA 53a will cause a change in the SPR signal, thereby detecting the target DNA 54.

FIG. 5b is similar to FIG. 5a. In this case, the nanodots 52 are functionalized with antibody probe molecules 53b. The antibody probe molecules 53b have an affinity for the target antigens 54b, but not for the antigens 55b. The binding of the target antigens 54b to the probe molecule antibodies 53b will cause a change in the SPR signal, thereby detecting the target antigen 54b.

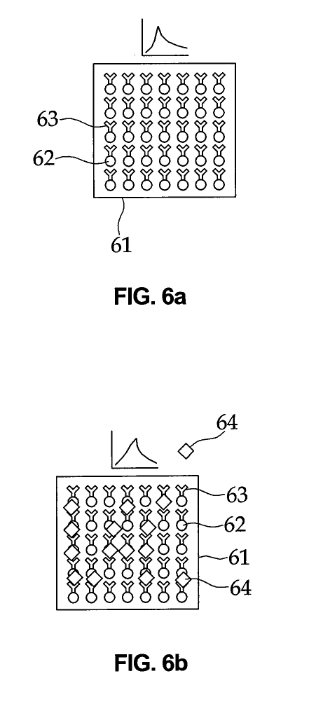

FIGS. 6a and 6b are another illustrative embodiments of the detection of target molecules using the substrates and systems disclosed herein. FIGS. 6a and 6b show the detection zone 61 of the substrate for the detection of target molecules. The nanodots 62 of the detection zone 61 are functionalized with probe molecules 63. The graphs of FIGS. 6a and 6b depict the SPR signal of the detection zone 61. In FIG. 6a, no target molecules are exposed to the probe molecules 63 functionalized with the nanodots 62 of the detection zone 61. In FIG. 6b, the detection zone 61 of the substrate for the detection of target molecules has been exposed to target molecules 64, some of which have bound to the probe molecules 63. The binding of the target molecules 64 to the probe molecules 63 causes a change in the resulting SPR signal as shown in the graph of FIG. 6b. In the graph of FIG. 6b, the peak value of the SPR signal moves from left to right.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A substrate for detecting one or more target molecules using surface plasmon resonance, the substrate comprising:
one or more detection zones on the surface of the substrate; and
a collection of nanodots disposed within one or more of the one or more detection zones,
wherein the nanodots are functionalized with one or more probe molecules having an affinity for the target molecules.

2. The substrate of claim 1, wherein the area of one or more of the one or more detection zones is from about 1 μm² to about 10,000 μm².

3. The substrate of claim 1, wherein the nanodots form a lattice pattern, a spiral pattern, a concentric circular pattern, or a radial pattern.

4. The substrate of claim 1, wherein the diameter of the nanodots is from about 1 nm to about 100 nm.

5. The substrate of claim 1, wherein the nanodots comprise a metal.

6. The substrate of claim 5, wherein the metal is selected from the group consisting of Au, Ag, Cu, and Al.

7. The substrate of claim 1, wherein the probe molecules of one collection of nanodots disposed within one detection zone are different from the probe molecules of another collection of nanodots disposed within another detection zone.

8. The substrate of claim 1, wherein the probe molecules comprise biomolecules.

9. The substrate of claim 8, wherein the biomolecules are selected from the group consisting of DNA, RNA, peptides, and enzymes.

10. A system for detecting one or more target molecules using surface plasmon resonance, the system comprising:
the substrate of claim 1;
a light source adapted to generate a surface plasmon resonance signal from the substrate; and
a detector adapted to detect the signal.

11. The system of claim 10, wherein the power of the signal from one detection zone corresponds to a value obtained by multiplying the power of the signal from one nanodot in the detection zone by the number of nanodots disposed within the one detection zone.

12. The system of claim 10, wherein the area of one or more of the one or more detection zones is from about 1 μm² to about 10,000 μm².

13. The system of claim 10, wherein the nanodots form a lattice pattern, a spiral pattern, a concentric circular pattern, or a radial pattern.

14. The system of claim 10, wherein the diameter of the nanodots is from about 1 nm to about 100 nm.

15. The system of claim 10, wherein the nanodots comprise a metal selected from the group consisting of Au, Ag, Cu, and Al.

16. The system of claim 10, wherein the probe molecules of one collection of nanodots disposed within one detection zone are different from the probe molecules of another collection of nanodots disposed within another detection zone.

17. The system of claim 10, wherein the probe molecules comprise biomolecules selected from the group consisting of DNA, RNA, peptides, and enzymes.

18. A method of detecting one or more target molecules using surface plasmon resonance, the method comprising:
exposing a substrate to one or more target molecules, the substrate comprising:
one or more detection zones on the surface of the substrate; and
a collection of nanodots disposed within one or more of the one or more detection zones, wherein the nanodots are functionalized with one or more probe molecules having an affinity for the target molecules; and
measuring a surface plasmon resonance signal from the substrate.

19. The method of claim 18, wherein the power of the signal from one detection zone corresponds to a value obtained by multiplying the power of the signal from one nanodot in the detection zone by the number of nanodots disposed within the one detection zone.

20. The method of claim 18, wherein the probe molecules are selected from the group consisting of DNA, RNA, peptides, and enzymes.

21. A method of manufacturing a substrate for detecting one or more target molecules using surface plasmon resonance, the method comprising:
forming one or more detection zones on the surface of the substrate; and
forming a collection of nanodots disposed within one or more of the one or more detection zones.

22. The method of claim 21, further comprising functionalizing the nanodots with one or more probe molecules having an affinity for the target molecules.

23. The method of claim 22, wherein the probe molecules of one collection of nanodots disposed within one detection zone are different from the probe molecules of another collection of nanodots disposed within another detection zone.

24. The method of claim 22, wherein the probe molecules are selected from the group consisting of DNA, RNA, peptides, and enzymes.

25. The method of claim 21, wherein the nanodots comprise a metal selected from the group consisting of Au, Ag, Cu, and Al.
